(19) United States
(12) Patent Application Publication
(10) Pub. No.: US 2026/0361840 A1
(43) Pub. Date: Nov. 12, 2026

(54) SPATIAL REALITY DISPLAY METHOD, SPATIAL REALITY DISPLAY SYSTEM, AND NON-TRANSITORY COMPUTER-READABLE STORAGE MEDIUM

(71) Applicant: BOE TECHNOLOGY GROUP CO., LTD., Beijing (CN)

(72) Inventors: Xitong MA, Beijing (CN); Xingxing ZHAO, Beijing (CN); Ran DUAN, Beijing (CN)

(21) Appl. No.: 19/124,859

(22) PCT Filed: Oct. 30, 2023
(86) PCT No.: PCT/CN2023/127651

§ 371 Date: Apr. 26, 2025

(30) Foreign Application Priority Data
Oct. 31, 2022 (CN) 202211351069.X

(51) Int. Cl. H04N 13/302; H04N 13/351; H04N 13/383

(52) U.S. Cl. CPC H04N 13/302; H04N 13/351; H04N 13/383

(57) ABSTRACT

Spatial reality display method and spatial reality display system are provided. The spatial reality display method includes establishing a coordinate system according to parameters of a display module; and determining an attribute parameter of a periodic unit corresponding to left eye views and right eye views for realizing 3D display in real time according to coordinates of positions of human eyes and coordinates of parameters of the display module in the coordinate system. A first sub-pixel group and a second sub-pixel group are determined according to the parameters of the display module and the attribute parameter of the periodic unit corresponding to the left eye views and the right eye views, and a left eye data stream and a right eye data stream are respectively output on the display module through the first sub-pixel group and the second sub-pixel group.

### CROSS-REFERENCE TO RELATED APPLICATIONS

The present application claims the priority of the Chinese Patent Application No. 202211351069.X filed on Oct. 31, 2022, the content of which is incorporated herein by reference in its entirety.

### TECHNICAL FIELD

The present disclosure relates to the field of spatial reality display system technology, in particular to a spatial reality display method, a spatial reality display system, and a non-transitory computer-readable storage medium.

### BACKGROUND

A technology for realizing stereoscopic vision effects without external tools such as polarized glasses is collectively called the naked-eye 3D (three-dimensional) display. In the related 3D display technology, a viewing angle of a viewer is fit by moving a position of a display screen, so that a better naked-eye 3D display effect is realized. However, regarding fitting the viewing angle of the viewer by moving the position of the display screen, it is generally difficult to locate positions suitable for human eyes by moving the display screen, so that the naked-eye 3D display effect is poor.

### SUMMARY

Embodiments of the present disclosure provide a spatial reality display method, a spatial reality display system, and a non-transitory computer-readable storage medium, so as to solve or alleviate one or more technical problems in the prior art.

As an aspect of an embodiment of the present disclosure, an embodiment of the present disclosure provides a spatial reality display method, including: acquiring positions of human eyes, parameters of a display module including a plurality of sub-pixels, a left eye data stream and a right eye data stream for realizing 3D display; establishing a coordinate system according to the parameters of the display module; determining attribute parameters of a periodic unit corresponding to left eye views and right eye views according to coordinates of the positions of human eyes and coordinates of the parameters of the display module in the coordinate system, wherein the attribute parameters of the periodic unit include a width of the periodic unit and an abscissa of a boundary of the periodic unit, the width of the periodic unit is a sum of widths of a left eye view and a right eye view adjacent to each other in the left eye views and the right eye views, and the abscissa of the boundary of the periodic unit is an abscissa of a boundary between two adjacent periodic units; and dividing the plurality of sub-pixels into a first sub-pixel group and a second sub-pixel group according to the parameters of the display module, the width of the periodic unit corresponding to the left eye views and the right eye views and the abscissa of the boundary of the periodic unit, and first sub-pixels in the first sub-pixel group are sub-pixels for outputting the left eye data stream in the display module, and second sub-pixels in the second sub-pixel group are sub-pixels for outputting the right eye data stream in the display module.

As another aspect of the embodiment of the present disclosure, an embodiment of the present disclosure further provides a spatial reality display system configured to implement the spatial reality display method in all embodiments of the present disclosure.

As another aspect of the embodiment of the present disclosure, an embodiment of the present disclosure further provides a non-transitory computer-readable storage medium having stored thereon a program that when executed by a processor, causes the processor to implement the spatial reality display method in all embodiments of the present disclosure.

The following beneficial effects can be obtained by adopting the above technical solutions in the embodiment of the present disclosure.

In the embodiments of the present disclosure, the coordinate system is established based on the parameters of the display module, and the attribute parameters of the period unit corresponding to the left eye views and the right eye views are determined in real time through the coordinates of positions of human eyes and coordinates of physical parameters of the display module in the coordinate system. The left eye views and the right eye views of the display module for realizing the 3D display may be determined based on the attribute parameters of the periodic unit corresponding to the left eye views and the right eye views. When the left eye views and the right eye views have been determined, the first sub-pixel group and the second sub-pixel group may be determined through the physical parameters of the display module and the attribute parameters of the periodic unit corresponding to the left eye views and the right eye views, and the left eye data stream and the right eye data stream are respectively output on the display module through the first sub-pixel group and the second sub-pixel group, so that sub-pixels of the display module are redistributed according to the positions of human eyes to fit/adapt/match the positions of human eyes of a viewer. Therefore, the viewer can clearly view the naked-eye 3D display at different angles or different positions without moving the display screen, and the problem that the naked-eye 3D display effect is poor due to the fact that it is difficult to accurately locate the positions of human eyes by moving the display screen, thereby causing a high naked-eye 3D visual effect, and improving the viewing experience of the viewer.

The foregoing summary is provided for the purpose of description only and is not intended to be limiting in any way. In addition to the illustrative aspects, embodiments, and features described above, further aspects, embodiments, and features of the present disclosure will be readily apparent by reference to the drawings and the following detailed description.

### BRIEF DESCRIPTION OF DRAWINGS

In the drawings, like reference numerals designate like or similar parts or elements throughout the drawings unless otherwise specified. The drawings are not necessarily to scale. It should be understood that these drawings only illustrate some embodiments in accordance with the present disclosure and are not to be considered to limit the scope of the present disclosure.

FIG. 1 shows a flowchart of a spatial reality display method according to an embodiment of the present disclosure.

FIG. 2 shows a schematic diagram of a spatial reality display method implemented in a coordinate system according to an embodiment of the present disclosure.

FIG. 3 shows a flowchart of a spatial reality display method according to an embodiment of the present disclosure.

FIG. 4 shows a flowchart of a spatial reality display method according to an embodiment of the present disclosure.

FIG. 5 shows a flowchart of a spatial reality display method according to an embodiment of the present disclosure.

FIG. 6 is a timing diagram illustrating the spatial reality displaying method in the embodiment of FIG. 5.

FIG. 7 shows a schematic diagram illustrating a structure of a spatial reality display system according to an embodiment of the present disclosure.

Description of reference numerals is as follows:

700. A display system; 710. A display device; 720. A signal output device; 730. A human eye recognition device; 731. An acquisition device; 732. A recognition device.

### DETAIL DESCRIPTION OF EMBODIMENTS

In the following, only certain exemplary embodiments are briefly described. As one of ordinary skill in the art would realize, the described embodiments may be modified in various different ways, all without departing from the spirit or scope of the present disclosure. Accordingly, the drawings and the description are to be regarded as illustrative in nature, and not as restrictive.

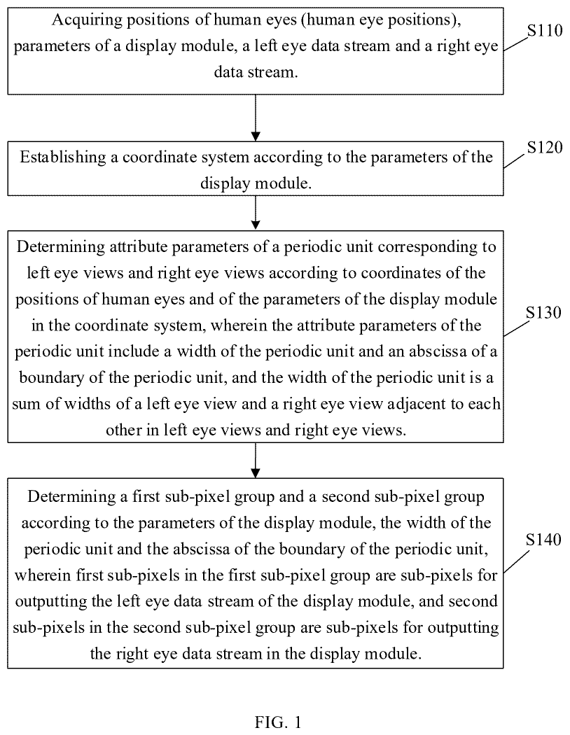

FIG. 1 shows a flowchart of a spatial reality display method according to an embodiment of the present disclosure. As shown in FIG. 1, the spatial reality display method includes steps S110 to S140.

The step S110 includes acquiring positions of human eyes (human eye positions), a parameter of a display module, a left eye data stream and a right eye data stream.

The step S120 includes establishing a coordinate system according to the parameter of the display module.

The step S130 includes determining an attribute parameter of a periodic unit corresponding to a left eye view and a right eye view according to the positions of human eyes and coordinates of the parameter of the display module in the coordinate system, wherein the attribute parameter of the periodic unit includes a width of the periodic unit and an abscissa of a boundary of the periodic unit, and the width of the periodic unit is the sum of widths of a left eye view and a right eye view adjacent to each other in left eye views and right eye views.

The step S140 includes determining a first sub-pixel group and a second sub-pixel group according to the parameter of the display module, the width of the periodic unit corresponding to the left eye view and the right eye view and the abscissa of the boundary of the periodic unit, wherein a first sub-pixel in the first sub-pixel group is a sub-pixel for outputting the left eye data stream in the display module, and a second sub-pixel in the second sub-pixel group is a sub-pixel for outputting the right eye data stream in the display module.

The spatial reality display method in the embodiment of the present disclosure may be applicable to a display system, and specifically may be directly executed on a naked-eye 3D display module. For example, the spatial reality display method is executed through a processor, or a processing chip or the like in the display module for displaying on the display module. Alternatively, the spatial reality display method is executed by another controller or processor, to control the naked-eye 3D display module to output the left eye data stream on the first sub-pixel and output the right eye data stream on the second sub-pixel. The display module may be a display screen, or a display or the like or other device for the naked-eye 3D display. In the following embodiments, the display system is taken as an execution subject for illustration.

In the embodiment of the present disclosure, the coordinate system is established based on the parameter of the display module, and the attribute parameter of the period unit corresponding to the left eye view and the right eye view are determined in real time (i.e., for each frame of image in a video) through the positions of human eyes and coordinates of a physical parameter of the display module on the coordinate system. The left eye view and the right eye view of the display module for realizing the 3D display may be determined based on the attribute parameter of the periodic unit corresponding to the left eye view and the right eye view. When the left eye view and the right eye view have been determined, the first sub-pixel group and the second sub-pixel group may be determined through the parameter of the display module and the attribute parameter of the periodic unit corresponding to the left eye view and the right eye view, and the left eye data stream and the right eye data stream are respectively output on the display module through the first sub-pixel group and the second sub-pixel group, so that sub-pixels in the display module are redistributed according to the positions of human eyes to fit the positions of human eyes of a viewer. Therefore, the viewer can clearly view the naked-eye 3D display at different angles or different positions without moving the display screen, and the problem that the naked-eye 3D display effect is poor due to the fact that it is difficult to accurately locate the positions of human eyes by moving the display screen, thereby causing a high naked-eye 3D visual effect, and improving the viewing experience of the viewer.

In the step S110, positions of human eyes, a parameter of a display module, a left eye data stream and a right eye data stream are acquired.

The left eye data stream and the right eye data stream are generally determined according to a video signal. For example, the left eye data stream and the right eye data stream may be obtained after a video stream is received and analyzed by a display device. The video signal is a signal carrying video playback content. For the naked-eye 3D, the key point is to project different images of video streams to the left eye and the right eye with the binocular parallax, thereby producing a 3D visual effect for the human eyes. That is, the video signal needs to be analyzed to obtain a data stream, and the data stream in the video signal is divided into the left eye data stream and the right eye data stream, where the left eye data stream is used to control the 3D display module to output a video stream (for example, a left eye visual image) suitable for being viewed by the left eye, and the right eye data stream is used to control the 3D display module to output a video stream (for example, a right eye visual image) suitable for being viewed by the right eye, so as to form a naked-eye 3D visual image on the 3D display module.

There are usually video signals in different modes, according to which different processing is required. For example, for a video signal in a 3D-FrameByFrame mode with a non-synchronous timing sequence, a left eye video stream and a right eye video stream in the video signal are adjusted, so that the left eye data stream and the right eye data stream generated by the left eye video stream and the right eye video stream can be synchronous, thereby avoiding the problem of poor naked-eye 3D visual effect caused by the non-synchronous left eye data stream and right eye data stream.

For example, for a video signal in a 3D-SideBySide mode (in a parallel mode) with a synchronous timing sequence, a size of the video signal is limited by an input interface and an output interface between a device generating the 3D content and the display system, and the video signal is generally a video with an 8K resolution. At this time, the video signal is divided into a left eye video stream and a right eye video stream, so that each of the left eye data stream and the right eye data stream generated by the left eye video stream and the right eye video stream is a data stream with a resolution less than or equal to 4K. Such the data stream is output to the 3D display module, so that the display effect is poor, the display resolution is low, and the naked-eye 3D viewing experience is poor. When processing the video signal, after the video signal is divided into the left eye video stream and the right eye video stream, a horizontal stretching process is performed on the left eye video stream and the right eye video stream, respectively, so that the resolution is effectively improved, a clearer frame of image can be output on the 3D display module, and the display effect of the naked-eye 3D image can be ensured.

In some embodiments, the video signal may be a signal of 3D content, and the 3D content may be generated on a personal computer (PC), such as a 3D software (e.g., UE/Unity). In some embodiments, the video signal may alternatively be generated by a laptop, a 3D content generation processor, or a cloud server, for example, or even on some mobile terminals. The generation of the 3D content is not limited in the present disclosure. A device for generating the video signal may be a device in the display system or a device outside the display system, which transmits the generated video signal to the display system, so that the resolution of the video signal is 7680× 4320 @ 60 Hz, and the video signal may be in the 3D-SideBySide mode (in the parallel mode) or the 3D-FrameByFrame mode (in a time-series mode). Specifically, the video signal may be output to the display system through an output interface HDMI 2.0×4. The output video signal may include a video image at a video resolution of 7680×4320 @ 60 Hz. Correspondingly, the display system is provided with an HDMI_RX module electrically connected to the output interface, and the HDMI_RX module includes an HDMI 2.0×4 interface for receiving the video signal.

The left eye data stream and the right eye data stream may be determined according to the video signal. The left eye data stream is used to control the 3D display module to output a video stream (for example, a left eye visual image) suitable for being viewed by the left eye, and the right eye data stream is used to control the 3D display module to output a video stream (for example, a right eye visual image) suitable for being viewed by the right eye, so as to form a naked-eye 3D visual image.

Human eye position information may be recognized by a visual recognition device to determine the positions of human eyes based on the human eye position information. Coordinates of the positions of human eyes in the established coordinate system may include a position coordinate (a coordinate of a position) of the left eye and a position coordinate of the right eye, and may further include a coordinate of a position between the left eye and the right eye, and the position coordinates may be three-dimensional coordinates or two-dimensional coordinates. In some embodiments, a face image may be acquired by a camera, and the positions of human eyes may be determined by recognizing the face image with a human eye recognition device, such as a System on Chip (SOC), or a trained neural network, or the like. Alternatively, an integrated visual recognition device may be adopted to directly recognize the human eye position information and determine the positions of human eyes based on the human eye position information. The visual recognition device may be a part of the display system, or a device externally and electrically connected to the display system, which transmits the generated position coordinates of human eyes including the position coordinate of the left eye, the position coordinate of the right eye and the coordinate of the position between the left eye and the right eye to the display system, so that the display system may acquire the position coordinates of human eyes.

The display module may be a 3D module, and the 3D module in this embodiment and other embodiments is the display module. The display module includes a display panel, so that an image with the naked-eye 3D display effect may be output, and therefore, the viewer may view the 3D image.

A naked-eye 3D display module generally includes a lens-based 3D display module and a slit-grating-based 3D display module. The slit-grating-based naked-eye 3D display module includes a 2D liquid crystal display and a slit grating. By loading image coding information of a plurality of viewpoints on the 2D display, different parallax images may be imaged at different positions in space, and accordingly the naked-eye 3D display effect is achieved. A cylindrical-lens-grating-based naked-eye 3D display module generally includes a 2D liquid crystal display and a cylindrical lens grating. A display principle of the cylindrical-lens-grating-based naked-eye 3D display module is similar to that of a slit grating stereoscopic display, and is specifically that stereoscopic vision is realized by encoding parallax images at different angles on a 2D display panel. The cylindrical lens grating is usually formed by arranging a plurality of cylindrical lenses with the same structure in parallel. The cylindrical lens is usually made of transparent medium materials, so that the cylindrical lens does not have a shielding effect on the light when modulating and coding the 2D image. Compared with the slit grating, the cylindrical-lens-grating-based naked-eye 3D display has the high brightness. In the present disclosure, the spatial reality display method and the spatial reality display system will be described by taking the lens 3D display module as an example. However, as described above, the imaging principle of the lens-based 3D display module is substantially similar to that of the slit-grating-based 3D display module, so that the spatial reality display method and the spatial reality display system described below in the present disclosure are also applicable to the slit-grating-based 3D display module.

The physical parameter of the display module include a length, a width and a height of the display module, a center of a surface of the display module, a length, a width and a height of a liquid crystal screen of the display module, a size and an arrangement of a prism of the display module, a length direction and a width direction of the display module, a surface vertical direction of the display module, and a pixel arrangement in the liquid crystal screen of the display module and the like. The physical parameter of the display module is fixed for the formed display module and generally, cannot be changed with the conventional movement and the conventional operation for the display module. The parameter of the display module is usually stored in a memory of the display module or recorded in a corresponding position when the display module leaves factory. The display device of the embodiment of the present disclosure may acquire the parameter of the display module by reading the memory of the display module or by means of human input. Alternatively, a model of the display module is determined by reading, and then, the parameter of the display module may be acquired in a space, such as a database or the internet, with the record of the model of the display module.

In the embodiment of the present disclosure, the parameter of the display module at least includes a center of an upper surface of the display module (i.e., a surface facing the user), a vertical direction of the upper surface of the display module, a width direction of the display module, a first width of a prism of the display module, a first distance from a surface of the prism (a prism surface) to a liquid crystal screen in the display module, and a second width of the liquid crystal screen in the display module. The parameter of the display module may further include a second distance between a midpoint of each sub-pixel of the liquid crystal screen and an edge of the liquid crystal screen in the display module, or the like. The first distance from the surface of the prism to the liquid crystal screen in the display module may be equal to or be not equal to a thickness of the prism, which depends on a design for the display module, and belongs to the physical attributes of the display module. The parameter of the display module is a known physical attribute when the display module leaves factory.

In the step S120, a coordinate system is established according to the parameter of the display module.

As described above for the display module, it can be known that the parameter of the display module includes the center of the upper surface of the display module, the vertical direction of the upper surface of the display module, and the width direction of the display module, and may alternatively include other parameters, such as the length direction of the display module, the center of the surface of the liquid crystal screen in the display module, and the like.

In the embodiment of the present disclosure, a two-dimensional coordinate system is established with the center of the upper surface of the display module as an origin, the vertical direction of the upper surface of the display module as a Z coordinate axis direction, and the width direction of the display module as an X coordinate axis direction. In an optional embodiment, a three-dimensional coordinate system may be established with the center of the upper surface of the display module as an origin, the vertical direction of the upper surface of the display module as a Z coordinate axis direction, the width direction of the display module as an X coordinate axis direction, and the length direction of the display module as a Y coordinate axis direction. In an optional embodiment, a two-dimensional or three-dimensional coordinate system may be established with the center of the surface of the liquid crystal screen in the display module as an origin. In the present disclosure, it is necessary to determine the sub-pixel arrangement for the left eye data stream and the right eye data stream, and further to determine the corresponding position coordinates of the left eye and the right eye. In this regard, the coordinate system should include at least a coordinate system associated with the width direction of the display module, the vertical direction of the display module, so that the position coordinates of human eyes may be positioned in the two-dimensional or three-dimensional coordinate system, thereby determining the arrangement of the first sub-pixel group and the second sub-pixel group for the left eye data stream and the right eye data stream. The coordinate system may be adjusted as needed, and is not limited herein.

In the step S130, an attribute parameter of a periodic unit corresponding to a left eye view and a right eye view is determined according to the positions of human eyes and coordinates of the parameter of the display module in the coordinate system, wherein the attribute parameter of the periodic unit includes a width of the periodic unit and an abscissa of a boundary of the periodic unit, and the width of the periodic unit is the sum of widths of a left eye view and a right eye view adjacent to each other in left eye views and right eye views.

As described above, in the present disclosure, as an example, the display module includes a plurality of sets of prisms and a liquid crystal screen. The liquid crystal screen is further away from a viewer than the prisms, and the viewer obtains a display image of the liquid crystal screen through the prisms.

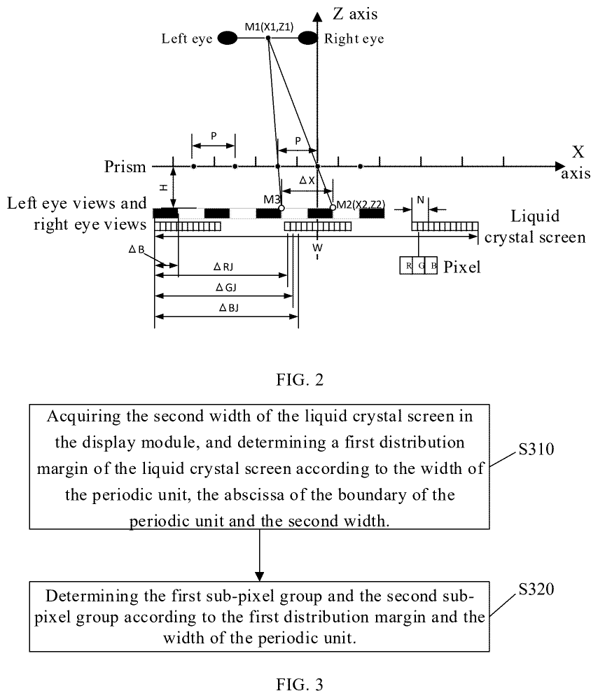

It can be seen according to the embodiment that the parameter of the display module includes the first width of the prism of the display module, the first distance from the surface of the prism to the liquid crystal screen in the display module and other related physical attributes. The first width of the prism in the embodiment of the present disclosure is a width of a single prism. As shown in FIG. 2, the first width P of the prism belongs to the determined attribute of the display module during the design, production and manufacture, and may be directly obtained. Similarly, the first distance H from the surface of the prism to the liquid crystal screen may be directly obtained according to a design parameter of the display module, where the first distance H is specifically the minimum distance between a surface of the prism away from the liquid crystal screen and the surface of the liquid crystal screen, that is, the first distance H may also be directly obtained according to the physical attributes of the display module.

In the embodiment of the present disclosure, the periodic unit is a minimum unit formed by a left eye view and a right eye view adjacent to each other in a plurality of left eye views and a plurality of right eye views distributed on the liquid crystal screen of the display module and divided by one frame of image for realizing the 3D display. Along the width direction of the liquid crystal screen, the left eye views and the right eye views are alternately arranged and the plurality of periodic units are sequentially arranged, thereby forming the arrangement for the left eye views and the right eye views of the liquid crystal screen of the display module for producing the naked-eye 3D display effect. That is, the left eye views and the right eye views are respectively left images and right images divided by outputting one frame of display image in the left eye data stream and the right eye data stream through the first sub-pixel group and the second sub-pixel group on the liquid crystal screen, so as to realize the 3D display effect. That is, the periodic unit is a minimum unit formed by the left eye view and the right eye view adjacent to each other in the left eye views and the right eye views, and at least corresponds to a first sub-pixel and a second sub-pixel on the display screen.

From the viewpoint of viewer vision, the content viewed by the viewer actually includes the left eye view and the right eye view. For the left eye view and the right eye view, the arrangement of the left eye view and the right eye view is determined by the periodic unit and the boundary of the periodic unit, and the arrangement is related to the width of the liquid crystal screen in the display module, and also may be related to the arrangement of sub-pixels in the width direction. The liquid crystal screen may be divided in the width direction according to the width of the period unit by taking the abscissa of the boundary of the period unit as a starting point, so that the arrangement of the left eye view and the right eye view on the display screen may be obtained. The boundary of the periodic unit may be an edge of the liquid crystal screen, or a boundary of an interface between two periodic units.

The attribute parameter of the periodic unit corresponding to the left eye view and the right eye view is determined according to the positions of human eyes and the coordinates of the parameter of the display module in the coordinate system, that is, the width of the periodic unit and the abscissa of the boundary of the periodic unit are determined.

FIG. 2 shows a schematic diagram of a spatial reality display method implemented in a coordinate system according to an embodiment of the present disclosure. As shown in FIG. 2, in order to facilitate determination of the width of the period unit and the abscissa of the boundary of the period unit, in the embodiment of the present disclosure, a three-dimensional coordinate system is established with a true center of the screen (a true center of the upper surface of the 3D module) as an origin, a direction perpendicular to the surface of the prism as a Z axis, the width direction of the upper surface of the prism as an X axis, and the length direction of the prism as a Y axis. The coordinates of the positions of human eyes are determined in the three-dimensional coordinate system.

The left eye views and the right eye views are adaptively arranged so that the left eye may see the left eye view (in FIG. 2, the black part is the left eye view in of the left eye views and the right eye views) output by the left eye data stream, and the right eye may see the right eye view (the white part is the right eye view of the left eye views and the right eye views) output by the right eye data stream, of the viewer at the current viewing angle. It is understood that the left eye views and the right eye views are generated by dividing each frame of image with respect to the display screen for implementing the naked-eye 3D display effect. When the viewing angle of an viewer is changed, the arrangement of the left eye views and the right eye views on the display screen is accordingly changed, so that it can be ensured to realize the good naked-eye 3D display effect at any angle for the viewer. The left eye views and the right eye views are used as a display effect view in the present disclosure. The left eye views and the right eye views are constructed by the first sub-pixels and the second sub-pixels, the left eye views are constructed with the left eye data stream being inputted to the first sub-pixels, and the right eye views are constructed with the right eye data stream being inputted to the second sub-pixels. The first sub-pixel group and the second sub-pixel group may be determined based on the left eye views and the right eye views. A coordinate M1(X1, Z1) of a midpoint of a line connecting the left eye and the right eye is calculated according to the following formulas (1) and (2) through a left eye position coordinate ML(XL, ZL) and a right eye position coordinate MR(XR, ZR) of the positions of human eyes. It is also possible that the coordinates M1(X1, Z1) of the midpoint of the line connecting the left eye and the right eye is already included in the position coordinates of human eyes.

$$X 1 = \frac{XL + XR}{2} \qquad ( 1 )$$

$$Z 1 = \frac{ZL + ZR}{2} \qquad ( 2 )$$

The width of the periodic unit for the left eye view and the right eye view is determined according to the first width, the first distance and the position coordinates of human eyes. The specific way is as follows.

As shown in FIG. 2, in the prism-based 3D display module, in order to obtain the naked-eye 3D display effect, the width of the prism corresponds to the width of the periodic unit for the left eye view and the right eye view displayed on the liquid crystal screen. As shown in FIG. 2, each periodic unit is composed of a left eye view and a right eye view of a minimum unit adjacent to each other.

As shown in FIG. 2, specifically, the width of the periodic unit may be obtained as follows: the midpoint M1 of the line connecting the left eye and the right eye is connected to two ends of the prism, respectively, to form two connecting lines, which are extended to the surface of the liquid crystal screen to form two intersection points M2 and M3 with the liquid crystal screen. A portion between the two intersection points M2 and M3 in the image displayed by the liquid crystal screen is the periodic unit for the left eye view and the right eye view, that is, a minimum unit of the distribution of the left eye view and the right eye view. The left eye views and the right eye views of one frame of display image are repeatedly arranged in the width direction of the display screen by taking the periodic unit as a unit, that is, the sub-pixels on the display screen are divided into corresponding first sub-pixel groups and second sub-pixel groups according to the arrangement of the left eye views and the right eye views on the display screen, the left eye data stream is input to the first sub-pixels in the first sub-pixel groups, and the right eye data stream is input to the second sub-pixels in the second sub-pixel groups, so that the left eye views and the right eye views may be formed. Therefore, by determining a distance between the two intersection points M2 and M3, the width of one period unit for the left eye view and the right eye view may be determined. The upper surface of the prism and the upper surface of the liquid crystal screen are generally kept parallel with each other according to the physical characteristics of the display module, or negligible errors may exist therein. Specifically, the midpoint of the line connecting the left eye and the right eye is connected to two ends of the prism, respectively, to form a triangle. The midpoint of the line connecting the left eye and the right eye, the intersection points M2 and M3 form another triangle. The upper surface of the prism and the upper surface of the liquid crystal screen are generally kept parallel with each other, that is, bases of such the two triangles are parallel with each other, so that such the two triangles are similar triangles.

Based on the similar triangles, together with the first width P of the prism, the coordinate M1(X1, Z1) of the midpoint of the line connecting the left eye and the right eye, and the first distance H from the prism surface to the liquid crystal screen, the width ΔX of one periodic unit for the left eye view and the right eye view may be calculated by the following formula (3) and formula (4) derived from the formula (3);

$$\frac{P}{Δ X} = \frac{Z 1}{Z 1 + H} \qquad ( 3 )$$

$$Δ X = P \times \frac{Z 1}{Z 1 + H} \qquad ( 4 )$$

The abscissa of the boundary of the periodic unit, that is, an abscissa of the intersection point M2, may be calculated based on the first width P of the prism, the coordinate M1(X1, Z1) of the midpoint of the line connecting the left eye and the right eye, the first distance H from the prism surface to the liquid crystal screen, and the width ΔX of the periodic unit for the left eye view and the right eye view. In the coordinate system, the abscissa of the intersection point M2 is an X axis coordinate of the intersection point M2.

In the present embodiment, in order to facilitate calculation of the abscissa of the intersection point M2, one end of the prism is set as a center of the surface of the display screen, i.e., an origin of the three-dimensional coordinate system, and therefore, a coordinate of the end is (0, 0). A Z axis coordinate Z2 of the intersection point M2 is H, and the coordinates of the intersection point M2 (the abscissa of the intersection point M2 and the Z axis coordinate of the intersection point M2) and the origin of the coordinate system form a triangle. An X axis coordinate and a Z axis coordinate of the midpoint M1 of the line connecting the left eye and the right eye and the origin of the coordinate system form another triangle. The upper surface of the prism and the upper surface of the liquid crystal screen are generally kept parallel with each other, that is, bases of such the two triangles are parallel with each other, so that such the two triangles are similar triangles.

Based on the similar triangles, the coordinates M1(X1, Z1) of the midpoint of the line connecting the left eye and the right eye and the first distance H from the prism surface to the liquid crystal screen (i.e., the Z axis coordinate Z2 of the intersection point M2 is H) of the similar triangle, the abscissa X2 of the boundary of the periodic unit may be calculated by the following formula (5) and formula (6) derived from the formula (5):

$$\frac{X 2}{H} = \frac{- X 1}{Z 1} \qquad ( 5 )$$

$$X 2 = \frac{- X 1 \times H}{Z 1} \qquad ( 6 )$$

Under the condition that the width of the periodic unit and the abscissa of the boundary of the periodic unit have been determined, the specific arrangement of all the left eye views and right eye views of one frame of image may be determined according to the width of the liquid crystal screen.

In the step S140, a first sub-pixel group and a second sub-pixel group are determined according to the parameter of the display module, the width of the periodic unit corresponding to the left eye view and the right eye view and the abscissa of the boundary of the periodic unit, wherein a first sub-pixel in the first sub-pixel group is a sub-pixel for outputting the left eye data stream in the display module, and a second sub-pixel in the second sub-pixel group is a sub-pixel for outputting the right eye data stream in the display module.

The left eye view in the left eye views and right eye views is generated in a case that the first sub-pixel group outputs the left eye data stream, the right eye view is generated in a case that the second sub-pixel group outputs the right eye data stream, and one first sub-pixel and one second sub-pixel are correspondingly provided on two sides of the boundary of the periodic unit, respectively. The abscissa of the boundary of each periodic unit arranged in the width direction of the liquid crystal screen may be determined according to the width of the liquid crystal screen and the width of the periodic unit. The position of each sub-pixel of the liquid crystal screen is known, and therefore, a coordinate of a center position of each sub-pixel is divided by the width of the periodic unit through the determined abscissa of the boundary of each periodic unit to determine the periodic unit corresponding to the sub-pixel together with a remainder. Further, through the judgment for the remainder, it may be determined whether the sub-pixel is the first sub-pixel or the second sub-pixel. Specifically, if the remainder of the sub-pixel is greater than a half of the width of the periodic unit, the sub-pixel is determined to be the second sub-pixel. If the remainder of the sub-pixel is less than or equal to a half of the width of the periodic unit, the sub-pixel is determined to be the first sub-pixel. Based on this, the first sub-pixel and the second sub-pixel can be accurately determined without physical adjustment. That is, only by controlling the left eye data stream to be input to the first sub-pixel group and the right eye data stream to be input to the second sub-pixel group, the viewer can realize a good naked-eye 3D viewing effect.

The determined first sub-pixel group in the embodiment of the present disclosure is a group of first sub-pixels, and the second sub-pixel group is a group of second sub-pixels.

In the embodiment of the present disclosure, the first sub-pixel group and the second sub-pixel group may be determined, and the corresponding left eye data stream and the corresponding right eye data stream may be output based on the first sub-pixel group and the second sub-pixel group, so that the viewer may clearly view the naked-eye 3D display effect. Moreover, in the present disclosure, it is only necessary to acquire the eye positions, and then to determine the coordinates of the eye positions in the coordinate system, which may include three-dimensional coordinates of the left eye and three-dimensional coordinates of the right eye. The rearrangement process of determining the first sub-pixel and the second sub-pixel based on the change of the positions of human eyes only involves the coordinates of the Z axis and the X axis, so that the coordinate value of the Y axis of the positions of human eyes does not need to be obtained, and only the coordinate values of the X axis and the Z axis of the positions of human eyes need to be obtained. That is, in the present disclosure, it is only necessary to obtain the coordinate values of the X axis and Z axis of the left eye and the coordinate values of the X axis and Z axis of the right eye in the position coordinates of human eyes. In addition, the coordinate of the midpoint of the line connecting the left eye and the right eye is used in the calculation process. That is, the position coordinate of human eyes may refer to only the three-dimensional coordinate of the midpoint of the line connecting the left eye and the right eye, or the X axis coordinate and the Z axis coordinate of the midpoint of the line connecting the left eye and the right eye.

The first sub-pixel group for outputting the left eye data stream in the display module and the second sub-pixel group for outputting the right eye data stream in the display module are determined through the position coordinates of human eyes. A first image with respect to the left eye and a second image with respect to the right eye may be generated by controlling the left eye data stream to be output in the first sub-pixel group and the right eye data stream to be output in the second sub-pixel group, thereby causing a high naked-eye 3D visual effect according to the positions of human eyes, and improving the viewing experience of the viewer.

When the viewing angle or the position of the viewer is changed, position coordinates of human eyes are re-determined, a first sub-pixel group and a second sub-pixel group are re-determined according to the position coordinates of human eyes, a left eye data stream is controlled to be output in the first sub-pixel group, a right eye data stream is controlled to be output in the second sub-pixel group, and a first image with respect to the left eye and a second image with respect to the right eye may be generated again. A logic rearrangement is realized for the sub-pixels in the 3D display module when the viewing angle or the position of the viewer is changed, so that the positions of human eyes of the viewer are re-adapted, and therefore, the viewer can clearly view the 3D image without physical adjustment for the display system, the error caused by the physical adjustment is avoided, the display effect can be improved and the user experience is improved more effectively.

In some embodiments, the parameter of the display module includes the center of the upper surface of the display module, the vertical direction of the upper surface of the display module, and the width direction of the display module. The determining the coordinate system according to the parameter of the display module includes following step.

The step includes determining the coordinate system by taking the center of the upper surface of the display module as an origin, the vertical direction of the upper surface of the display module as a first coordinate axis direction and the width direction of the display module as a second coordinate axis direction.

It can be seen according to the above embodiment that the parameter of the display module may include the physical attributes of the display module, such as the center of the upper surface of the display module, the vertical direction of the upper surface of the display module, and the width direction of the display module and the like, and may further include other parameters such as the length direction of the display module and the like.

In the embodiment of the present disclosure, the rearrangement process of determining the first sub-pixel and the second sub-pixel only involves the coordinates of the Z axis and the X axis, so that the coordinate value of the Y axis of the positions of human eyes does not need to be obtained, and only the coordinate values of the X axis and the Z axis of the positions of human eyes need to be obtained. That is, it is only necessary to obtain the coordinate values of the X axis and Z axis of the left eye and the coordinate values of the X axis and Z axis of the right eye in the position coordinates of human eyes.

A two-dimensional coordinate system is established by taking the center of the upper surface of the display module (the true center of the upper surface of the 3D module) as an origin, the vertical direction of the upper surface of the display module as the Z axis direction and the width direction of the display module as the X axis direction, and the position coordinates of human eyes are converted into the two-dimensional coordinate system. Therefore, the width of the periodic unit and the abscissa of the boundary of the periodic unit in the attribute parameter of the periodic unit can be conveniently calculated, the calculation amount is reduced, and the efficiency of processing the 3D content is improved.

Alternatively, a three-dimensional coordinate system may be established by taking the length direction of the display module as the Y axis direction on the basis of the two-dimensional coordinate system, which will not be described in detail herein.

In some embodiments, the parameter of the display module includes the first width of the prism of the display module and the first distance from the surface of the prism of the display module to the liquid crystal screen. The width of the periodic unit for the left eye view and the right eye view and the abscissa of the boundary of the periodic unit are determined according to the position coordinates of human eyes, the parameter of the display module and the coordinate system, which includes following step.

The step includes determining the width of the periodic unit and the abscissa of the boundary of the periodic unit according to the first width, the first distance, the position coordinates of human eyes and the coordinate system.

The first width of the prism in the embodiment of the present disclosure is a width of a single prism. The first width P of the prism may be directly determined according to the design of the prism, that is, the first width P belongs to the determined attribute of the display module during the design, production and manufacture, and may be directly obtained. Similarly, the first distance H from the surface of the prism to the liquid crystal screen may be directly obtained according to a design parameter of the display module, where the first distance H is specifically the minimum distance between a surface of the prism away from the liquid crystal screen and the surface of the liquid crystal screen, that is, the first distance H may alternatively be directly obtained according to the physical attributes of the display module.

In the embodiment of the present disclosure, the coordinate system established in the above embodiment is a two-dimensional coordinate system or a three-dimensional coordinate system. The position coordinates of human eyes are converted into the coordinate system. The periodic unit for the left eye view for outputting the left eye data stream and the right eye view for outputting the right eye data stream on the display module is calculating through the similar triangles according to the position coordinates of human eyes, the first distance and the first width. In the left eye views and the right eye views, any one left eye view corresponds to at least one first sub-pixel for outputting the left eye data stream, and any one right eye view corresponds to at least one second sub-pixel for outputting the right eye data stream. The corresponding left eye data stream and right eye data stream are output based on the first sub-pixel and the second sub-pixel, so that the viewer can clearly view the naked-eye 3D effect.

In the embodiment of the present disclosure, the first width of the prism of the display module and the first distance from the surface of the prism of the display module to the liquid crystal screen belong to the physical attributes of the display module, and therefore, may be easily acquired. According to the embodiment of the present disclosure, the width of the periodic unit and the abscissa of the boundary of the periodic unit can be conveniently and quickly calculated and determined, so that the first sub-pixel group for displaying the left eye view and the second sub-pixel group for displaying the right eye view can be easily obtained, without introducing other variables, and the system errors are reduced.

As shown in FIG. 3, in some embodiments, the parameter of the display module includes the second width of the liquid crystal screen in the display module. The determining the first sub-pixel group and the second sub-pixel group according to the parameter of the display module, the width of the periodic unit for the left eye view and the right eye view, and the abscissa of the boundary of the periodic unit includes steps S310 to S320.

The step S310 includes acquiring the second width of the liquid crystal screen of the display module, and determining a first distribution margin of the liquid crystal screen according to the width of the periodic unit, the abscissa of the boundary of the periodic unit and the second width. The first distribution margin may be regarded as a remaining part of the liquid crystal screen excluding a maximal integral multiple of periodic units that the liquid crystal screen includes (that is, the first distribution margin is a remaining part of the liquid crystal screen excluding a part of the second width of the liquid crystal screen corresponding to the maximal integral multiple of periodic units), a width of the remaining part on the X axis is less than the width of one periodic unit, and a width of a part of the liquid crystal screen excluding the remaining part is integral multiple of the width of the periodic unit.

The step S320 includes determining the first sub-pixel group and the second sub-pixel group according to the first distribution margin and the width of the periodic unit.

The display module includes the second width of the liquid crystal screen in the display module, which is the whole width of the liquid crystal screen, that is, the whole width of the liquid crystal screen in the horizontal direction, for example, a width of the liquid crystal screen along the X axis direction shown in FIG. 2. The first sub-pixel group and the second sub-pixel group are determined according to the first distribution margin and the width of the periodic unit. In the case where the viewer is at an angle with respect to the vertical direction of the true center of the upper surface of the 3D display module, a structure of the display module is fixed, that is, the pixel arrangement of the liquid crystal screen is fixed, so that when the abscissa of the boundary of the periodic unit is calculated from the width of the periodic unit after the width of the periodic unit and the abscissa of the boundary of the periodic unit are determined, there may be a case where the edge of the liquid crystal screen is exceeded, that is, the width of the liquid crystal screen cannot be equally divided into periodic units, that is, the liquid crystal screen does not include a whole structure including the evenly arranged periodic units without the margin. Thus, there is a margin, that is, the first distribution margin, where there is no left eye view or right eye view, at the edge of the liquid crystal screen. The influence on the first sub-pixel and the second sub-pixel needs to be taken into account at this time. If it is determined from the width of the periodic unit and the abscissa of the boundary of the periodic unit that the liquid crystal screen includes a whole structure including the arranged periodic units without the margin, that is, all the sub-pixels of the entire liquid crystal screen may generate the corresponding left eye view and right eye view, the margin does not need to be considered.

The second width W of the liquid crystal screen belongs to the whole width of the liquid crystal screen, belongs to the physical attribute of the display module and may be directly obtained.

The first distribution margin of the liquid crystal screen is determined according to the width of the periodic unit, the abscissa of the boundary of the periodic unit and the second width. The periodic units for the left eye view and the right eye view are sequentially arranged on two sides according to the width of the periodic unit by taking the abscissa of the boundary of the periodic unit determined by calculation as a starting point. In the embodiment of the present disclosure, the influence of the abscissa of the boundary of the periodic unit on the first distribution margin Δ B needs to be considered. Generally, there is a margin with the left eye view and the right eye view at the edge of the liquid crystal screen. That is, there is a part at the edge of the liquid crystal screen, the part is located behind the sequentially arranged periodic units with the corresponding width and cannot cover a width of a single periodic unit. For example, the part may cover a half or a quarter of the width of the periodic unit, and the part serves as the margin and is referred to as the first distribution margin in the present disclosure. In one embodiment, for determining the first sub-pixel and the second sub-pixel, it is only necessary to consider that there is the first distribution margin at the edge on one side of the liquid crystal screen, so that as many sub-pixels as possible on the liquid crystal screen participate in the display. Therefore, how to calculate the first distribution margin ΔB is discussed in the present disclosure by taking the presence of the first distribution margin Δ B at the edge on one side of the liquid crystal screen as an example. The result may be obtained according to formula (7):

$$Δ B = MOD ( X 2 + W / 2 , Δ X ) \qquad ( 7 )$$

Where X2 is the abscissa of the boundary of the periodic unit, ΔX is the width of the periodic unit, and W is the second width of the liquid crystal screen.

The first distribution margin ΔB may be obtained by the formula (7). Specifically, after each periodic unit is determined, the position of each sub-pixel of the liquid crystal screen is known, and therefore, a sum of the width of each sub-pixel and the first distribution margin is divided by the width of the periodic unit to determine the periodic unit corresponding to the sub-pixel together with a remainder. Through the judgment for the remainder, it may be further determined whether the sub-pixel is the first sub-pixel or the second sub-pixel. Specifically, if the remainder of the sub-pixel is greater than a half of the width of the periodic unit, the sub-pixel is determined to be the second sub-pixel. If the remainder of the sub-pixel is less than or equal to a half of the width of the periodic unit, the sub-pixel is determined to be the first sub-pixel. Based on this, the first sub-pixel and the second sub-pixel can be accurately determined without physical adjustment. That is, only by controlling the left eye data stream to be input to the first sub-pixel group and the right eye data stream to be input to the second sub-pixel group, the viewer can realize a good naked-eye 3D viewing effect.

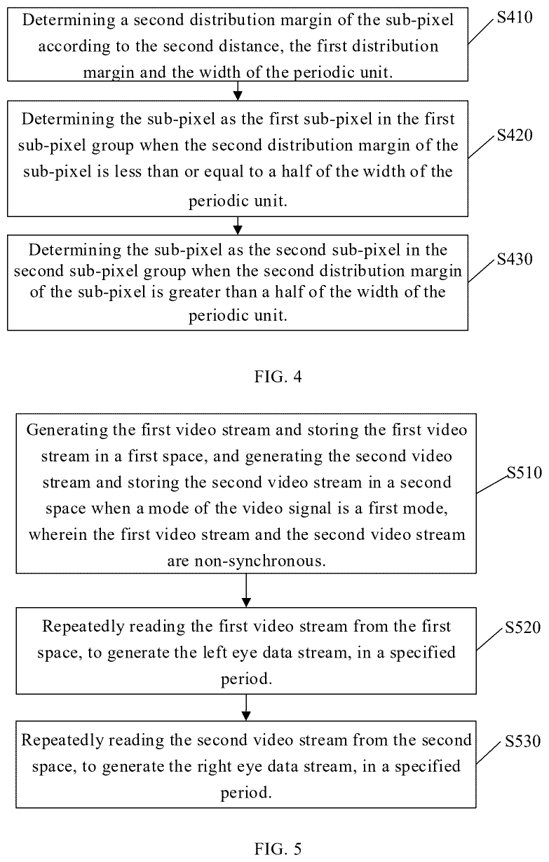

As shown in FIG. 4, in some embodiments, the parameter of the display module further includes the second distance between the midpoint of each sub-pixel of the liquid crystal screen and the edge of the liquid crystal screen in the display module. The determining the first sub-pixel group and the second sub-pixel group according to the first distribution margin and the width of the periodic unit includes steps S410 to S430.

The step S410 includes determining a second distribution margin of the sub-pixel according to the second distance, the first distribution margin and the width of the periodic unit.

The step S420 includes determining the sub-pixel as the first sub-pixel in the first sub-pixel group when the second distribution margin of the sub-pixel is less than or equal to a half of the width of the periodic unit.

The step S430 includes determining the sub-pixel as the second sub-pixel in the second sub-pixel group when the second distribution margin of the sub-pixel is greater than a half of the width of the periodic unit.

For the display module, a physical location of each pixel on the liquid crystal screen is known. In the present disclosure, implementing the sub-pixel rearrangement refers to adjusting an output content of whether the left eye view or the right eye view is input into the sub-pixel. For example, one sub-pixel is taken as the first sub-pixel displaying the left eye view or the second sub-pixel displaying the right eye view. In the embodiment of the present disclosure, the sub-pixel rearrangement in the liquid crystal screen can produce the naked-eye 3D effect adapting to the positions of the eyes of the viewer, and the image content output by each sub-pixel is changed substantially.

In the embodiment of the present disclosure, it is necessary to determine the edge of the liquid crystal screen where the first distribution margin exists, then determine a position of each sub-pixel relative to the edge of the liquid crystal screen, and determine whether the current sub-pixel outputs the left eye data stream as the first sub-pixel or outputs the right eye data stream as the second sub-pixel. Each pixel generally includes three sub-pixels, a red sub-pixel R, a green sub-pixel G, and a blue sub-pixel B, and the second distance between the midpoint of each sub-pixel and the edge of the liquid crystal screen is determined by formulas (8) to (10) below.

$$Δ RJ = J \times N - \frac{5}{6} \times N \qquad ( 8 )$$

$$Δ GJ = J \times N - \frac{3}{6} \times N \qquad ( 9 )$$

$$Δ BJ = J \times N - \frac{1}{6} \times N \qquad ( 10 )$$

Where ΔRJ is a second distance between a midpoint of a red sub-pixel and the edge of the liquid crystal screen; AGJ is a second distance between a midpoint of a green sub-pixel and the edge of the liquid crystal screen; ΔBJ is a second distance between a midpoint of a blue sub-pixel and the edge of the liquid crystal screen; J represents a column number of a pixel; and N is a pixel width. Each pixel generally includes two red sub-pixels, two green sub-pixels and two blue sub-pixels arranged side by side, so that according to the arrangement of the sub-pixels in the pixel,

$$\frac{5}{6} \times N$$

is subtracted for the red sub-pixel,

$$\frac{3}{6} \times N$$

is subtracted for the green sub-pixel, and

$$\frac{1}{6} \times N$$

is subtracted for the blue sub-pixel.

After the second distance between the midpoint of each sub-pixel and the edge of the liquid crystal screen is determined, it is necessary to determine a remainder of a quotient obtained by dividing the second distance between the midpoint of each sub-pixel and the edge of the liquid crystal screen by the width of the periodic unit. The first distribution margin indicated in the above embodiments exists, and therefore, the first distribution margin needs to be considered here. The second distribution margin may be determined according to the following formulas (11) to (13).

$$Position R = MOD ( Δ RJ + Δ X - Δ B , Δ X ) \qquad ( 11 )$$

$$Position G = MOD ( Δ GJ + Δ X - Δ B , Δ X ) \qquad ( 12 )$$

$$Position B = MOD ( Δ BJ + Δ X - Δ B , Δ X ) \qquad ( 13 )$$

Where Position R is a second distribution margin of the red sub-pixel; Position G is a second distribution margin of the green sub-pixel; Position B is a second distribution margin of the blue sub-pixel; ΔRJ is the second distance between the midpoint of the red sub-pixel and the edge of the liquid crystal screen; AGJ is the second distance between the midpoint of the green sub-pixel and the edge of the liquid crystal screen; ΔBJ is the second distance between the midpoint of the blue sub-pixel and the edge of the liquid crystal screen; ΔX is the width of the periodic unit; and ΔB is the first distribution margin. In the formulas (11) to (13), each divisor is increased by ΔX before the remainder is obtained to avoid negatives in the calculation.

After determining the second distribution margin of each sub-pixel, whether each sub-pixel belongs to the first sub-pixel or the second sub-pixel is determined according to the following:

With Position

$$R \leq \frac{Δ X}{2} ,$$

the red sub-pixel is determined to be the first sub-pixel for inputting the left eye data stream;

With Position

$$R > \frac{Δ X}{2} ,$$

the red sub-pixel as is determined to be the second sub-pixel for inputting the right eye data stream;

With Position

$$B \leq \frac{Δ X}{2} ,$$

the blue sub-pixel is determined to be the first sub-pixel for inputting the left eye data stream;

With Position

$$B > \frac{Δ X}{2} ,$$

the blue sub-pixel is determined to be the second sub-pixel for inputting the right eye data stream;

With Position

$$G \leq \frac{Δ X}{2} ,$$

the green sub-pixel is determined to be the first sub-pixel for inputting the left eye data stream;

With Position

$$G > \frac{Δ X}{2} ,$$

the green sub-pixel is determined to be the second sub-pixel for inputting the right eye data stream.

As above, the first sub-pixel and the second sub-pixel may be accurately determined without the physical adjustment for the display module, only the left eye data stream is controlled to be input into the first sub-pixel and the right eye data stream is controlled to be input into the second sub-pixel, and the viewer may view the 3D content in the naked-eye 3D mode.

In some embodiments, the spatial reality display method further includes following steps.

A video signal is acquired.

The left eye data stream and the right eye data stream are determined according to the video signal.

The video signal may be a signal of 3D content, and the 3D content may be generated on a personal computer (PC), such as a 3D software (e.g., UE/Unity). In some embodiments, the video signal may alternatively be generated by a laptop, a 3D content generation processor, or a cloud server, for example, or even on some mobile terminals. The generation of the 3D content is not limited in the present disclosure. A device for generating the video signal may be a device in the display system or a device outside the display system, which transmits the generated video signal to the display system, so that the resolution of the video signal is 7680× 4320 @ 60 Hz, and the video signal may be in the 3D-SideBySide mode (in the parallel mode) or the 3D-FrameByFrame mode (in a time-series mode). Specifically, the video signal may be output to the display system through an output interface HDMI 2.0×4. The output video signal may include a video image at a video resolution of 7680×4320 @ 60 Hz. Correspondingly, the display system is provided with an HDMI_RX module electrically connected to the output interface, and the HDMI_RX module includes an HDMI 2.0×4 interface for receiving the video signal.

The left eye data stream and the right eye data stream may be determined according to the video signal. The left eye data stream is used to control the 3D display module to output a video stream (for example, a left eye visual image) suitable for being viewed by the left eye, and the right eye data stream is used to control the 3D display module to output a video stream (for example, a right eye visual image) suitable for being viewed by the right eye, so as to form a naked-eye 3D visual image.

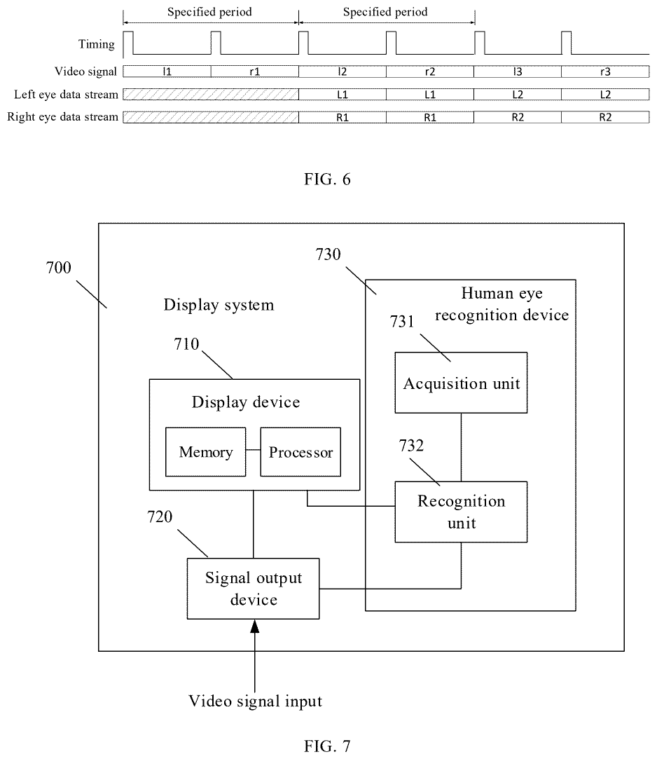

In some embodiments, as shown in FIGS. 5 and 6, the determining the left eye data stream and the right eye data stream according to the video signal, includes steps S510 to S530.

The step S510 includes when a mode of the video signal is a first mode, generating the first video stream and storing the first video stream in a first space, and generating the second video stream and storing the second video stream in a second space, wherein the first video stream and the second video stream are non-synchronous.

The step S520 includes repeatedly reading the first video stream from the first space, to generate the left eye data stream, in a specified period.

The step S530 includes repeatedly reading the second video stream from the second space, to generate the right eye data stream, in a specified period.

In FIG. 6, 1 represents a single frame of image in the first video stream, r represents a single frame of image in the second video stream, L represents a single frame of image in the left eye data stream, and R represents a single frame of image in the right eye data stream.

Whether the video signal is in the first mode or a second mode may be determined by manual input or analyzing of the video signal.

In the first mode, the first video stream and the second video stream are non-synchronous. For example, for a video signal in a 3D-FrameByFrame mode with a non-synchronous timing sequence, the left eye video stream and the right eye video stream in the video signal are non-synchronous, which results in the poor naked-eye 3D image.

The first space and the second space are included in a storage space of the display system, wherein the first space is an address space for odd-numbered frames, and the second space is an address space for even-numbered frames. Alternatively, the first space is an address space for even-numbered frames, and the second space is an address space for odd-numbered frames. A size of the first space and a size of the second space are determined based on the physical resolution of the 3D display module.

In the embodiment of the present disclosure, the first video stream is stored in the first space, the second video stream is stored in the second space, that is, the address space for odd-numbered frames is used to store the left eye data, and the even-numbered frames is used to store the right eye data. Specifically, in the display system, the left eye video stream is stored in the address space for odd-numbered frames and the right eye video stream is stored in the address space for even-numbered frames.

When the video streams in the first space and the second space are synchronously read, the existence of complete frame data in the address space for odd-numbered frames and the address space for even-numbered frames is ensured.

The method includes repeatedly reading the first video stream from the first space, to generate the left eye data stream, in the specified period, and repeatedly reading the second video stream from the second space, to generate the right eye data stream, in the specified period. The specified period may be a period time of 2 frames or 4 frames.

Alternatively, the specified period may be set according to actual conditions. By repeatedly reading the first video stream and the second video stream in the specified period to generate the left eye data stream and the right eye data stream, the non-synchronous first video stream and second video stream may be equalized in the specified period. That is, the first video stream and the second video stream of the same frame are read out in the specified period to generate the left eye data stream and the right eye data stream in synchronization with each other, which can prevent the poor naked-eye 3D image from being generated.

In some embodiments, the determining the left eye data stream and the right eye data stream from the video signal includes following steps.

When the mode of the video signal is determined to be the second mode, a third video stream and a fourth video stream are generated, wherein the third video stream and the fourth video stream are synchronous in the second mode.

The third video stream and the fourth video stream are stretched by a specified rate to generate the left eye data stream and the right eye data stream, wherein the specified rate is more than or equal to 2.

The video signal includes the synchronous third video stream and the fourth video stream, which may be obtained by analyzing the video signal.

In the second mode, the third video stream and the fourth video stream are parallel synchronous video streams. For example, for a video signal in a 3D-SideBySide mode (in a parallel mode) with a synchronous timing sequence, a size of the video signal is limited by an input interface and an output interface between a device generating the 3D content and the display system, and the video signal is generally a video with an 8K resolution. At this time, the video signal is divided into a left eye video stream and a right eye video stream, so that each of the left eye data stream and the right eye data stream generated by the left eye video stream and the right eye video stream is a data stream with a resolution less than or equal to 4K. Such the data stream is output to the 3D display module, so that the display effect is poor, the display resolution is low, and the naked-eye 3D viewing experience is poor.

When processing the video signal, after the video signal is divided into the left eye video stream and the right eye video stream, there is no bandwidth influence in the display system, and therefore, a sum of a size of the left eye video stream and a size of the right eye video stream may be greater than 8K. Therefore, the third video stream and the fourth video stream are stretched by the specified rate. After the left eye video stream and the right eye video stream are subjected to the horizontal stretching process, so that the resolution is effectively improved, a clearer frame of image can be output on the 3D display module, and the display effect of the naked-eye 3D image can be ensured.

In some embodiments, the video signal is identified as a video signal in a third mode, which is a 2D video stream, and at this time, the 2D video stream may be directly output to the 3D display module.

In some embodiments, the spatial reality display method may further include following steps.

Three-dimensional coordinates of the left eye and three-dimensional coordinates of the right eye are acquired.

The video signal is determined based on the three-dimensional coordinates of the left eye and the three-dimensional coordinates of the right eye.

In the embodiment of the present disclosure, the generation of the video signal may be accomplished by the display system, that is, the 3D content is generated on other device for generating the 3D content, and then the generated 3D content is transmitted to the display system. The display system acquires the three-dimensional coordinates of the left eye and the three-dimensional coordinates of the right eye from the visual recognition device. A three-dimensional coordinate system is established by taking the true center of a screen (the true center of the upper surface of the 3D display module) as an origin, the vertical direction of the surface of the prism as a Z axis, the width direction of the upper surface of the prism as an X axis and the length direction of the prism as a Y axis. The output 3D content is adjusted according to the three-dimensional coordinates of the left eye and the three-dimensional coordinates of the right eye, thereby generating the video signal.

The device for generating the 3D content may also be a part of the display system. The three-dimensional coordinates of the left eye and the three-dimensional coordinates of the right eye are acquired from the visual recognition device, and the 3D content is generated as the video information according to the three-dimensional coordinates of the left eye and the three-dimensional coordinates of the right eye.

In the embodiment of the present disclosure, the three-dimensional coordinates of the left eye and the three-dimensional coordinates of the right eye are introduced to generate the corresponding 3D content. Therefore, the 3D content can be adjusted according to the viewing angle of the viewer, and the first sub-pixel and the second sub-pixel for displaying the 3D content can be adjusted, so that the viewer can experience a better naked-eye 3D visual effect.

As another aspect of the embodiments of the present disclosure, the embodiment of the present disclosure provides a spatial reality display system. As shown in FIG. 7, a spatial reality display system 700 according to the embodiment of the present disclosure is configured to execute the spatial reality display method according to the embodiment of the present disclosure.

The display system 700 may be a naked-eye 3D display module. For example, the spatial reality display method is executed through a processor, or a processing chip or the like in the display module for displaying on the display module. Alternatively, the display system may include another controller or processor. After the spatial reality display method is executed on the display system 700, the naked-eye 3D display module is controlled to output the left eye data stream through the first sub-pixel group and output the right eye data stream through the second sub-pixel group.

In the spatial reality display system of the embodiment of the present disclosure, the first sub-pixels and the second sub-pixels of the liquid crystal screen in the display module are determined in real time through tracking the position coordinates of human eyes, the left eye data stream may be output in the first sub-pixels and the right eye data stream may be output in the second sub-pixels in real time according to the position coordinates of human eyes through outputting the left eye data stream in the first sub-pixels and outputting the right eye data stream in the second sub-pixels, so that the sub-pixels in the display module are redistributed according to the positions of the human eyes to fit the positions of the human eyes of a viewer. Therefore, the viewer can clearly view the naked-eye 3D display at different angles or different positions without moving the display screen, and the problem that the naked-eye 3D display effect is poor due to the fact that it is difficult to accurately locate the positions of the human eyes by moving the display screen, thereby causing a high naked-eye 3D visual effect, and improving the viewing experience of the viewer.

In some embodiments, the display system 700 includes a display device 710 and a signal output device 720.

The display device 710 includes a display module for 3D display, which includes a plurality of sub-pixels.

The signal output device 720 is electrically connected to the display device 710 and configured to transmit the left eye video stream and the right eye video stream generated based on the positions of the human eyes to the first pixel group and the second pixel group in the display device 710, respectively.

The signal output device 720 is, for example, a PC (personal computer), a notebook computer, a mobile terminal, a 3D content generation processor, or a cloud server. For example, a 3D video signal is generated based on the 3D content, such as the 3D content generated on a 3D software of a PC, or the 3D content generated on a UE/Unity.

The display device 710 described above may be integrated with a memory and a processor. Therefore, the spatial reality display method in the present disclosure may be stored in the memory as program instructions, and the processor executes the program instructions stored in the memory to implement the spatial reality display method. Specifically, the processor determines the first sub-pixel group for receiving the left eye video stream and the second sub-pixel group for receiving the right eye video stream on the display screen of the display module based on the left eye video stream and the right eye video stream output by the signal output device 720 and the physical parameter of the 3D display module included in the display device 710 stored in the memory to implement the 3D display.

In some embodiments, the display system 700 further includes a human eye recognition device 730.

The human eye recognition device 730 is electrically connected to the display device 710 and the signal output device 720 and configured to output the position coordinates of human eyes to the display device 710 and output the position coordinates of human eyes to the signal output device 720.

The human eye recognition device 730 may be an integrated visual recognition device, a human face image is captured by a camera provided by the human eye recognition device, and the three-dimensional coordinates of the left eye and the three-dimensional coordinates of the right eye in the position coordinates of human eyes are determined by a trained neural network or the like, and are respectively transmitted to the display device 710 and the signal output device 720, so that the display device 710 and the signal output device 720 may execute the above spatial reality display method.

In some embodiments, the human eye recognition device 730 further includes an acquisition unit 731 and a recognition unit 732.

The acquisition unit 731 is configured to acquire information regarding human eyes.

The recognition unit 732 is electrically connected to the acquisition unit 731, the display device 710 and the signal output device 720, and is configured to recognize information regarding the positions of human eye, and determine coordinates of the positions of the human eyes, where the information regarding the positions of human eyes includes the coordinates of the positions of human eyes, the three-dimensional coordinates of the left eye and the three-dimensional coordinates of the right eye. The recognition unit 732 is further configured to output the coordinates of the positions of human eyes to the display device 710, and output the three-dimensional coordinates of the left eye and the three-dimensional coordinates of the right eye to the signal output device 720.

The acquisition unit 731 may be a photographic camera or a camera or the like, and may acquire the human face image by using the camera, and the recognition unit 732 may be a human eye recognition device, such as an SOC (System on Chip), or a trained neural network, or the like, to recognize the human face image, and determine the position coordinates of human eyes. Alternatively, an integrated visual recognition device may be adopted to directly recognize the human eye coordinate information, wherein the human eye coordinate information includes the position coordinates of human eyes, the three-dimensional coordinates of the left eye and the three-dimensional coordinates of the left eye. The position coordinates of human eyes are transmitted to the display device 700 and the three-dimensional coordinates of the left eye and the three-dimensional coordinates of the right eye are transmitted to the signal output device 720, the display device 700 may acquire the position coordinates of human eyes, and the signal output device 720 may acquire the three-dimensional coordinates of the left eye and the three-dimensional coordinates of the right eye, so that the display device 700 and the signal output device 720 may execute the corresponding spatial reality display method.

Other configurations of the spatial reality display system in the above embodiments can adopt various technical solutions known by one of ordinary skill in the art now and in the future, and will not be described in detail here.

In the description of the present specification, it is to be understood that the terms “center”, “longitudinal”, “transverse”, “length”, “width”, “thickness”, “upper,” “lower”, “front”, “rear”, “left”, “right”, “vertical”, “horizontal”, “top”, “bottom”, “inner”, “outer”, “clockwise”, “counterclockwise”, “axial”, “radial”, “circumferential”, and the like are used in the orientations and positional relationships indicated in the drawings for convenience in describing the present disclosure and to simplify the description, but are not intended to indicate or imply that the device or element must have a particular orientation, be constructed and operated in a particular orientation, and are not to be construed as limiting the present disclosure.

Furthermore, the terms “first” and “second” are used for descriptive purposes only and are not to be construed as indicating or implying relative importance or implicitly indicating the number of technical features indicated. Thus, a feature defined by the term “first” or “second” may explicitly or implicitly include one or more of the features. In the description of the present disclosure, the term “more” means two or more unless specifically limited otherwise.

In this application, unless expressly stated or limited otherwise, the terms “mounted”, “connected to”, “connected with”, “secured”, and the like are to be construed broadly and encompass, for example, a fixed connection or a removable connection or an integral part. Further, these terms may encompass a mechanical connection, an electrical connection or a communication connection. Further, these terms may encompass a direct connection, an indirect connection through an intervening medium or an internal connection or an interaction between two elements. The specific meaning of the above terms in the present disclosure may be understood by one of ordinary skill in the art as the case may be.

In this application, unless expressly stated or limited otherwise, a first feature is “on” or “under” a second feature, which may mean that the first feature and the second feature are in direct contact with each other, or the first feature and the second feature are not in direct contact with each other, but in contact with each other through another feature between the first feature and the second feature. The first feature is “on”, “above” and “over” the second feature, which may mean that the first feature is directly above or obliquely above the second feature, or simply mean that the first feature is at a higher level than the second feature. The first feature is “under”, “beneath”, and “under” the second feature, which may mean that the first feature being directly under or obliquely under the second feature, or simply mean that the first feature is at a lesser level than the second feature.

The above disclosure provides many different embodiments, or examples, for implementing different features of the present disclosure. The components and arrangements in specific examples are described as above to simplify the present disclosure. Alternatively, they are merely examples and are not intended to limit the present disclosure. Further, reference numerals and/or reference letters may be repeated in the various examples of the present disclosure for simplicity and clarity, and do not in itself indicate a relationship between the arrangements in the various embodiments discussed. Any process or method descriptions in flow charts or otherwise described herein may be understood as representing modules, segments, or portions of code which include one or more executable instructions for implementing specific logical functions or steps in the process. The scope of the preferred embodiments of the present disclosure includes other implementations in which functions may be performed out of the order shown or discussed, including substantially concurrently or in reverse order, depending on the functionality involved.

For example, the logic and/or steps represented in the flowcharts or otherwise described herein may be considered as an ordered listing of executable instructions for implementing the logical functions, may be specifically embodied in any computer-readable medium for use by or in connection with an instruction execution system, an apparatus, or a device (such as a computer-based system, a system including a processor, or other system that may obtain the instructions from the instruction execution system, the apparatus, or the device and execute the instructions).

It should be understood that portions of the present disclosure may be implemented in hardware, software, firmware, or a combination thereof. In the above embodiments, the various steps or the method may be implemented in software or firmware stored in a memory and executed by a suitable instruction execution system. All or a portion of the steps of the method in the above embodiments may be performed by associated hardware instructed by a program, which may be stored in a computer-readable storage medium, and implement one or a combination of the steps of the method in the above embodiments when executed.

In addition, functional units in the embodiments of the present disclosure may be integrated into one single processing module, or the functional units may exist separately and physically, or two or more functional units are integrated into one single module. The integrated module may be realized in hardware, or in a software functional module. If the integrated module is realized in the form of the software functional module and sold or used as a separate product, the integrated module may alternatively be stored in a computer-readable storage medium. The storage medium may be a read-only memory, a magnetic or optical disk, or the like.

The detail description of embodiments of the present disclosure is as above, but the scope of the present disclosure should not be limited to the specific embodiments, and various changes and modifications may be easily made by one of ordinary skill in the art familiar with the technical field within the technical scope of the present disclosure, and such the changes and modifications also fall within the scope of the present disclosure. Therefore, the protection scope of the present disclosure shall be limited by the protection scope of the claims.

1. A spatial reality display method, comprising:
acquiring positions of human eyes, parameters of a display module comprising a plurality of sub-pixels, a left eye data stream and a right eye data stream for realizing 3D display;
establishing a coordinate system according to the parameters of the display module;
determining attribute parameters of a periodic unit corresponding to left eye views and right eye views for realizing 3D display according to coordinates of the positions of human eyes and coordinates of the parameters of the display module in the coordinate system, wherein the attribute parameters of the periodic unit comprise a width of the periodic unit and an abscissa of a boundary of the periodic unit, and the width of the periodic unit is a sum of widths of a left eye view and a right eye view adjacent to each other in the left eye views and the right eye views; and
dividing the plurality of sub-pixels into a first sub-pixel group and a second sub-pixel group according to the parameters of the display module, the width of the periodic unit and the abscissa of the boundary of the periodic unit, wherein first sub-pixels in the first sub-pixel group are sub-pixels for outputting the left eye data stream in the display module, and second sub-pixels in the second sub-pixel group are sub-pixels for outputting the right eye data stream in the display module.

2. The spatial reality display method according to claim 1, wherein the parameters of the display module comprise a center of an upper surface of the display module, a vertical direction of the upper surface of the display module, and a width direction of the display module; and
the establishing the coordinate system according to the parameters of the display module, comprises:
establishing the coordinate system by taking the center of the upper surface of the display module as an origin, the vertical direction of the upper surface of the display module as a first coordinate axis direction and the width direction of the display module as a second coordinate axis direction.

3. The spatial reality display method according to claim 1, wherein the parameters of the display module comprise a first width of one prism of a plurality of prisms in the display module and a first distance from a surface of the plurality of prisms to a liquid crystal screen of the display module; and
the determining the attribute parameters of the periodic unit corresponding to the left eye views and the right eye views for realizing 3D display according to the coordinates of the positions of human eyes and the coordinates of the parameters of the display module in the coordinate system, wherein the attribute parameters of the periodic unit comprise the width of the periodic unit and the abscissa of the boundary of the periodic unit, comprises:
determining the width of the periodic unit for the left eye views and the right eye views and the abscissa of the boundary of the periodic unit according to the first width, the first distance and the coordinates of the positions of human eyes in the coordinate system.

4. The spatial reality display method according to claim 1, wherein the parameters of the display module comprises a second width of a liquid crystal screen of the display module, and
the dividing the plurality of sub-pixels into the first sub-pixel group and the second sub-pixel group according to the parameters of the display module, the width of the periodic unit and the abscissa of the boundary of the periodic unit, comprises:
acquiring the second width of the liquid crystal screen of the display module;
determining a first distribution margin of the liquid crystal screen according to the width of the periodic unit, the abscissa of the boundary of the periodic unit and the second width, wherein the first distribution margin is a remaining part of the liquid crystal screen excluding a part of the liquid crystal screen corresponding to a maximal integral multiple of periodic units which the liquid crystal screen comprises; and
determining the first sub-pixel group and the second sub-pixel group according to the first distribution margin and the width of the periodic unit.

5. The spatial reality display method according to claim 4, wherein the first distribution margin is at an edge of the liquid crystal screen in the second coordinate axis direction.

6. The spatial reality display method according to claim 5, wherein the parameters of the display module further comprise a second distance from a midpoint of each sub-pixel of the liquid crystal screen of the display module to the edge of the liquid crystal screen; and
the determining the first sub-pixel group and the second sub-pixel group according to the first distribution margin and the width of the periodic unit, comprises:
determining a second distribution margin of the sub-pixel according to the second distance, the first distribution margin and the width of the periodic unit, wherein the second distribution margin is a remainder obtained by dividing a difference between the second distance and the first distribution margin by the width of the periodic unit;
determining the sub-pixel as the first sub-pixel in the first sub-pixel group in response to the second distribution margin of the sub-pixel being less than or equal to a half of the width of the periodic unit; and
determining the sub-pixel as the second sub-pixel in the second sub-pixel group in response to the second distribution margin of the sub-pixel being greater than a half of the width of the periodic unit.

7. The spatial reality display method according to claim 1, further comprising, prior to the acquiring the left eye data stream and the right eye data stream:
acquiring a video signal; and
determining the left eye data stream and the right eye data stream according to the video signal.

8. The spatial reality display method according to claim 7, wherein the determining the left eye data stream and the right eye data stream according to the video signal, comprises:
generating the first video stream and storing the first video stream in a first space, and generating the second video stream and storing the second video stream in a second space in response to a mode of the video signal being a first mode, wherein the first video stream and the second video stream are non-synchronous in the video signal in the first mode;
repeatedly reading the first video stream from the first space, to generate the left eye data stream, in a specified period; and
repeatedly reading the second video stream from the second space, to generate the right eye data stream, in a specified period.

9. The spatial reality display method according to claim 7, wherein the determining the left eye data stream and the right eye data stream according to the video signal, comprises:
generating a third video stream and a fourth video stream in response to a mode of the video signal being a second mode, wherein the third video stream and the fourth video stream are parallel synchronous video streams; and
stretching the third video stream and the fourth video stream by a specified multiple to generate the left eye data stream and the right eye data stream, wherein the specified multiple is greater than or equal to 2.

10. A spatial reality display system, comprising a display module, a processor and a memory, wherein the display module comprises a plurality of sub-pixels, the processor executes a program stored in the memory to perform a method, the method comprising:
receiving positions of human eyes, physical parameters of the display module, and a left eye data stream and a right eye data stream for realizing 3D display of the display module;
establishing a coordinate system according to the physical parameters of the display module;
determining attribute parameters of a periodic unit for left eye views and right eye views for realizing the 3D display of the display module according to coordinates of the positions of human eyes and coordinates of the physical parameters of the display module in the coordinate system, wherein the attribute parameters of the periodic unit comprise a width of the periodic unit and an abscissa of a boundary of the periodic unit, and the width of the periodic unit is a sum of widths of a left eye view and a right eye view adjacent to each other in the left eye views and the right eye views; and
dividing the plurality of sub-pixels into a first sub-pixel group and a second sub-pixel group according to the physical parameters of the display module, the width of the periodic unit and the abscissa of the boundary of the periodic unit, wherein first sub-pixels in the first sub-pixel group are sub-pixels for outputting the left eye data stream in the display module, and second sub-pixels in the second sub-pixel group are sub-pixels for outputting the right eye data stream in the display module.

11. The spatial reality display system according to claim 10, further comprising:
a signal output device configured to receive a video signal and be connected to the processor; and
a human eye recognition device electrically connected to the processor and comprising:
an acquisition unit configured to acquire the positions of human eyes; and
a recognition unit electrically connected to the acquisition unit and the processor, and configured to recognize the positions of human eyes, determine the positions of human eyes and output the positions of human eyes to the processor.

12. The spatial reality display system according to claim 10, wherein the parameters of the display module comprise a center of an upper surface of the display module, a vertical direction of the upper surface of the display module, and a width direction of the upper surface of the display module; and
the establishing the coordinate system according to the parameters of the display module, comprises:
establishing the coordinate system by taking the center of the upper surface of the display module as an origin, the vertical direction of the upper surface of the display module as a first coordinate axis direction and the width direction of the upper surface of the display module as a second coordinate axis direction.

13. The spatial reality display system according to claim 10, wherein the parameters of the display module comprise a first width of one prism of a plurality of prisms of the display module and a first distance from a surface of the plurality of prisms to a liquid crystal screen of the display module; and
the determining the width of the periodic unit and the abscissa of the boundary of the periodic unit according to the coordinates of the positions of human eyes and the coordinates of the parameters of the display module in the coordinate system, comprises:
determining the width of the periodic unit for the left eye views and the right eye views and the abscissa of the boundary of the periodic unit according to the first width, the first distance and the coordinates of the positions of human eyes in the coordinate system.

14. The spatial reality display system according to claim 10, wherein the parameters of the display module comprise a second width of a liquid crystal screen of the display module, and
the determining the first sub-pixel group and the second sub-pixel group according to the parameters of the display module, the width of the periodic unit and the abscissa of the boundary of the periodic unit, comprises:
acquiring the second width of the liquid crystal screen of the display module;
determining a first distribution margin of the liquid crystal screen according to the width of the periodic unit, the abscissa of the boundary of the periodic unit and the second width, wherein the first distribution margin is a remaining part of the liquid crystal screen excluding a part of the liquid crystal screen corresponding to a maximal integral multiple of periodic units which the liquid crystal screen comprises; and
determining the first sub-pixel group and the second sub-pixel group according to the first distribution margin and the width of the periodic unit.

15. The spatial reality display system according to claim 14, wherein the first distribution margin is at an edge of the liquid crystal screen in the second coordinate axis direction.

16. The spatial reality display system according to claim 15, wherein the parameters of the display module further comprise a second distance from a midpoint of each sub-pixel of the liquid crystal screen of the display module to the edge of the liquid crystal screen; and
the determining the first sub-pixel group and the second sub-pixel group according to the first distribution margin and the width of the periodic unit, comprises:
determining a second distribution margin of the sub-pixel according to the second distance, the first distribution margin and the width of the periodic unit, wherein the second distribution margin is a remainder obtained by dividing a difference between the second distance and the first distribution margin by the width of the periodic unit;
determining the sub-pixel as the first sub-pixel in the first sub-pixel group in response to the second distribution margin of the sub-pixel being less than or equal to a half of the width of the periodic unit; and
determining the sub-pixel as the second sub-pixel in the second sub-pixel group in response to the second distribution margin of the sub-pixel being greater than a half of the width of the periodic unit.

17. A non-transitory computer-readable storage medium having stored thereon instructions that when executed by a processor, cause the processor to perform a method, comprising:
acquiring positions of human eyes, parameters of a display module, a left eye data stream and a right eye data stream for realizing 3D display;
establishing a coordinate system according to the parameters of the display module;
determining attribute parameters of a periodic unit corresponding to left eye views and right eye views for realizing 3D display according to coordinates of the positions of human eyes and coordinates of the parameters of the display module in the coordinate system, wherein the attribute parameters of the periodic unit comprise a width of the periodic unit and an abscissa of a boundary of the periodic unit, and the width of the periodic unit is a sum of widths of a left eye view and a right eye view adjacent to each other in the left eye views and the right eye views; and
dividing the plurality of sub-pixels into a first sub-pixel group and a second sub-pixel group according to the parameters of the display module, the width of the periodic unit and the abscissa of the boundary of the periodic unit, wherein first sub-pixels in the first sub-pixel group are sub-pixels for outputting the left eye data stream in the display module, and second sub-pixels in the second sub-pixel group are sub-pixels for outputting the right eye data stream in the display module.

18. The non-transitory computer-readable storage medium according to claim 17, wherein the parameters of the display module comprise a center of an upper surface of the display module, a vertical direction of the upper surface of the display module, and a width direction of the upper surface of the display module; and
the establishing the coordinate system according to the parameters of the display module, comprises:
establishing the coordinate system by taking the center of the upper surface of the display module as an origin, the vertical direction of the upper surface of the display module as a first coordinate axis direction and the width direction of the upper surface of the display module as a second coordinate axis direction.

19. The non-transitory computer-readable storage medium according to claim 17, wherein the parameters of the display module comprise a first width of one prism of a plurality of prisms of the display module and a first distance from a surface of the prisms to a liquid crystal screen of the display module; and
the determining the width of the periodic unit and the abscissa of the boundary of the periodic unit according to the coordinates of the positions of human eyes and the coordinates of the parameters of the display module in the coordinate system, comprises:
determining the width of the periodic unit for the left eye views and the right eye views and the abscissa of the boundary of the periodic unit according to the first width, the first distance and the coordinates of the positions of human eyes in the coordinate system.

20. The non-transitory computer-readable storage medium according to claim 17, wherein the parameters of the display module comprise a second width of a liquid crystal screen of the display module, and
the determining the first sub-pixel group and the second sub-pixel group according to the parameters of the display module, the width of the periodic unit and the abscissa of the boundary of the periodic unit, comprises:
acquiring the second width of the liquid crystal screen of the display module;
determining a first distribution margin of the liquid crystal screen according to the width of the periodic unit, the abscissa of the boundary of the periodic unit and the second width, wherein the first distribution margin is a remaining part of the liquid crystal screen excluding a part of the liquid crystal screen corresponding to a maximal integral multiple of periodic units which the liquid crystal screen comprises; and
determining the first sub-pixel group and the second sub-pixel group according to the first distribution margin and the width of the periodic unit.
